(19) United States
(12) Patent Application Publication
(10) Pub. No.: US 2018/0348417 A1
(43) Pub. Date: Dec. 6, 2018

(54) OPTICAL FILM, POLARIZING PLATE, AND IMAGE DISPLAY DEVICE

(71) Applicant: FUJIFILM Corporation, Tokyo (JP)

(72) Inventors: Naozumi SHIRAIWA, Kanagawa (JP); Keita TAKAHASHI, Kanagawa (JP); Hiroshi SATO, Kanagawa (JP)

(73) Assignee: FUJIFILM Corporation, Tokyo (JP)

(21) Appl. No.: 16/053,029

(22) Filed: Aug. 2, 2018

Related U.S. Application Data
(63) Continuation of application No. PCT/JP2017/008114, filed on Mar. 1, 2017.

(30) Foreign Application Priority Data
Mar. 4, 2016 (JP) 2016-042481

(51) Int. Cl. G02B 5/30; C09K 19/34

(52) U.S. Cl. CPC G02B 5/3016; G02F 1/13363; C09K 19/3491

(57) ABSTRACT

An object of the present invention is to provide an optical film having an optically anisotropic layer having excellent durability, and a polarizing plate and an image display device using the same. An optical film of the present invention includes an optically anisotropic layer, an overcoat layer, and a pressure sensitive adhesive layer in this order, in which the optically anisotropic layer is a layer obtained by polymerizing a polymerizable liquid crystal composition containing a liquid crystal compound having a polymerizable group and a polymerization initiator, the overcoat layer is a layer obtained by curing a polyfunctional polymerizable monomer having two or more polymerizable groups, and a molecular weight per polymerizable group in the polyfunctional polymerizable monomer is 140 or less.

### CROSS-REFERENCE TO RELATED APPLICATIONS

This application is a Continuation of PCT International Application No. PCT/JP2017/008114 filed on Mar. 1, 2017, which claims priority under 35 U.S.C. § 119(a) to Japanese Patent Application No. 2016-042481 filed on Mar. 4, 2016. The above application is hereby expressly incorporated by reference, in its entirety, into the present application.

### BACKGROUND OF THE INVENTION

### 1. Field of the Invention

The present invention relates to an optical film, a polarizing plate, and an image display device.

### 2. Description of the Related Art

Optical films such as an optical compensation sheet and a phase difference film are used for various image display devices to eliminate image coloration and to broaden the viewing angle.

Stretched birefringent films have been employed as optical films. However, in recent years, instead of stretched birefringent films, the use of optical films having optically anisotropic layers formed of liquid crystal compounds has been proposed.

As such an optical film, for example, JP2010-031223A discloses an optical film obtained by polymerizing a compound which contains a predetermined group and a polymerizable group ([claim 12]).

### SUMMARY OF THE INVENTION

The present inventors have conducted investigations on the optical film disclosed in JP2010-031223A and have found that, in a case where an optically anisotropic layer to be formed is exposed to a high temperature and high humidity environment, there is a problem in durability that the birefringence index of the optically anisotropic layer changes depending on polymerization conditions such as the kind of a polymerizable liquid crystal compound and a polymerization initiator to be used and the curing temperature thereof.

Here, an object of the present invention is to provide an optical film having an optically anisotropic layer having excellent durability, and a polarizing plate and an image display device using the same.

As a result of intensive investigations to achieve the above object, the present inventors have found that satisfactory durability is obtained by providing a specific overcoat layer between an optically anisotropic layer formed by using a liquid crystal compound and a pressure sensitive adhesive layer, and thus have completed the present invention.

That is, it has been found that the above object can be achieved by adopting the following configurations.

[1] An optical film comprising, in order: an optically anisotropic layer; an overcoat layer; and a pressure sensitive adhesive layer,

in which the optically anisotropic layer is a layer obtained by polymerizing a polymerizable liquid crystal composition containing a liquid crystal compound having a polymerizable group and a polymerization initiator,

the overcoat layer is a layer obtained by curing a polyfunctional polymerizable monomer having two or more polymerizable groups, and

a molecular weight per polymerizable group in the polyfunctional polymerizable monomer is 140 or less.

[2] The optical film according to [1], in which the overcoat layer is a layer having no glass transition temperature or a layer having a glass transition temperature of 80° C. or higher.

[3] The optical film according to [1] or [2], in which the polymerizable group of the polyfunctional polymerizable monomer is an acryloyl group or a methacryloyl group.

[4] The optical film according to any one of [1] to [3], in which the liquid crystal compound is a liquid crystal compound represented by Formula (1).

[5] The optical film according to any one of [1] to [4], in which the polymerizable group of the liquid crystal compound is an acryloyl group or a methacryloyl group.

[6] The optical film according to any one of [1] to [5], in which the liquid crystal compound is a liquid crystal compound exhibiting reciprocal wavelength dispersion.

[7] A polarizing plate comprising: the optical film according to any one of [1] to [6]; and a polarizer.

[8] An image display device comprising: the optical film according to any one of [1] to [6]; or the polarizing plate according to [7].

According to the present invention, it is possible to provide an optical film having an optically anisotropic layer having excellent durability, and a polarizing plate and an image display device using the same.

### BRIEF DESCRIPTION OF THE DRAWINGS

FIG. 1 is a cross-sectional view schematically showing an example of an optical film according to the present invention.

FIG. 2 is a cross-sectional view schematically showing an example of a polarizing plate according to the present invention.

FIG. 3 is a cross-sectional view schematically showing an example (liquid crystal display device) of an image display device according to the present invention.

FIG. 4 is a cross-sectional view schematically showing another example (organic electroluminescent display device) of the image display device according to the present invention.

### DESCRIPTION OF THE PREFERRED EMBODIMENTS

Hereinafter, the present invention will be described in detail.

The description of the constitutional requirements described below is made on the basis of representative embodiments of the present invention, but it should not be construed that the present invention is limited to those embodiments.

In this specification, numerical value ranges expressed by the term “to” mean that the numerical values described before and after “to” are included as a lower limit and an upper limit, respectively.

[Optical Film]

An optical film of the present invention is an optical film having an optically anisotropic layer, an overcoat layer, and a pressure sensitive adhesive layer in this order.

In the optical film of the present invention, the optically anisotropic layer is a layer obtained by polymerizing a polymerizable liquid crystal composition containing a liquid crystal compound having a polymerizable group and a polymerization initiator.

In the optical film of the present invention, the overcoat layer is a layer obtained by curing a polyfunctional polymerizable monomer having two or more polymerizable groups and a molecular weight per polymerizable group in the polyfunctional polymerizable monomer is 140 or less.

In the present invention, by providing the overcoat layer obtained by curing the polyfunctional polymerizable monomer having a molecular weight per polymerizable group of 140 or less between the optically anisotropic layer and the pressure sensitive adhesive layer, durability becomes satisfactory.

Although the details are not clear, the present inventors have assumed as follows.

First, the present inventors have assumed that in a case where an optically anisotropic layer is exposed in a high temperature and high humidity environment, the birefringence changes because a low molecular compound such as an uncured monomer of a liquid crystal compound remaining in the optically anisotropic layer or a polymerization initiator is transferred to a pressure sensitive adhesive layer used for bonding of a display element such as a liquid crystal cell or an organic electroluminescent (hereinafter, abbreviated as “EL”) display panel to form gaps inside the optically anisotropic layer and thus the liquid crystal alignment is disordered.

As described above, it could be confirmed that the durability was improved by providing a specific overcoat layer between the optically anisotropic layer and the pressure sensitive adhesive layer.

Therefore, it is considered that the polyfunctional polymerizable monomer having a molecular weight per polymerizable group of 140 or less is cured to form a dense overcoat layer, and as a result, the low molecular compound remaining in the optically anisotropic layer can be prevented from being transferred to the pressure sensitive adhesive layer.

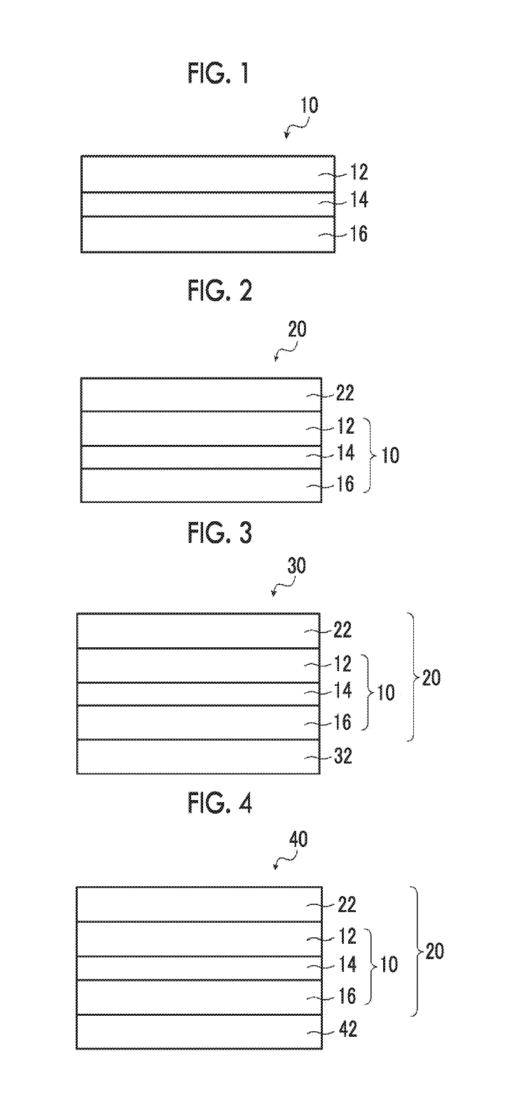

FIG. 1 is a cross-sectional view schematically showing an example of the optical film of the present invention.

FIG. 1 and FIGS. 2 to 4 described later are schematic views and the thickness relationship and positional relationship the respective layers or the like do not necessarily coincide with actual ones. Arbitrary constitutional members not inhibiting the effect of the present invention may be provided between the respective layers and on the surface of each layer.

An optical film 10 shown in FIG. 1 has an optically anisotropic layer 12, an overcoat layer 14, and a pressure sensitive adhesive layer 16 in this order.

Hereinafter, various members used for the optical film of the present invention will be described in detail.

[Optically Anisotropic Layer]

The optically anisotropic layer of the optical film of the present invention is a layer obtained by polymerizing a polymerizable liquid crystal composition containing a liquid crystal compound having a polymerizable group and a polymerization initiator.

<Liquid Crystal Compound>

The polymerizable liquid crystal composition for forming the optically anisotropic layer includes a liquid crystal compound having a polymerizable group.

Herein, generally, liquid crystal compounds are classified into a rod-like type and a disk-like type according to the shape thereof. Further, each includes a low molecular type and a high molecular type. The term “high molecular” generally refers to a compound having a degree of polymerization of 100 or more (Polymer Physics-Phase Transition Dynamics, by Masao Doi, p. 2, published by Iwanami Shoten, Publishers, 1992). In the present invention, any type of liquid crystal compound can be used, but a rod-like liquid crystal compound or a discotic liquid crystal compound (disk-like liquid crystal compound) is preferably used. Two or more kinds of rod-like liquid crystal compounds, two or more kinds of disk-like liquid crystal compounds, or a mixture of a rod-like liquid crystal compound and a disk-like liquid crystal compound may be used. In order to fix the above-described liquid crystal compound, the optically anisotropic layer is more preferably formed using a rod-like liquid crystal compound or disk-like liquid crystal compound having a polymerizable group, and the liquid crystal compound still more preferably has two or more polymerizable groups in one molecule. In the case of a mixture of two or more kinds of the liquid crystal compounds, at least one kind of liquid crystal compound preferably has two or more polymerizable groups in one molecule.

As the rod-like liquid crystal compound, for example, the rod-like liquid crystal compounds described in claim 1 of JP1999-513019A (JP-H11-513019A) or paragraphs [0026] to [0098] of JP2005-289980A can be preferably used, and, as the discotic liquid crystal compounds, for example, the discotic liquid crystal compounds described in paragraphs [0020] to [0067] of JP2007-108732A and paragraphs [0013] to [0108] of JP2010-244038A can be preferably used, but the liquid crystal compounds are not limited thereto.

In the present invention, for the reason that a more remarkable effect of improving durability according to the present invention can be obtained, the liquid crystal compound having a polymerizable group is preferably a liquid crystal compound represented by Formula (1).

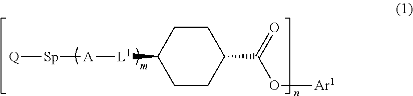

Herein, in Formula (1), Ar¹ represents an n-valent aromatic group,

L¹ represents a single bond, —COO—, or —OCO—,

A represents an aromatic ring having 6 or more carbon atoms or a cycloalkylene ring having 6 or more carbon atoms,

Sp represents a single bond, a linear or branched alkylene group having 1 to 12 carbon atoms, or a divalent linking group in which one or more —CH₂— groups that constitute a linear or branched alkylene group having 1 to 12 carbon atoms are substituted with —O—, —S—, —NH—, —N(Q)-, or —CO—, and

Q represents a polymerizable group, m represents an integer of 0 to 2, and n represents an integer of 1 or 2.

Herein, all of L¹, A, Sp, and Q, a plurality of which are provided depending on the number of m or n, may be the same or different from each other.

In Formula (1), an aromatic group represented by Ar¹ refers to a group having a ring having aromaticity and for example, an n-valent group having at least one aromatic ring selected from the group consisting of an aromatic hydrocarbon ring and an aromatic heterocyclic ring may be used. Herein, examples of the aromatic hydrocarbon ring include a benzene ring, a naphthalene ring, an anthracene ring, and a phenanthroline ring, and examples of the aromatic heterocyclic ring include a furan ring, a pyrrole ring, a thiophene ring, a pyridine ring, a thiazole ring, and a benzothiazole ring. Among these, a benzene ring, a thiazole ring, and a benzothiazole ring are preferable.

In addition, in Formula (1), examples of an aromatic ring having 6 or more carbon atoms represented by A includes the examples of the aromatic ring included in Ar¹ described above, and among these, a benzene ring (for example, 1,4-phenyl group) is preferable. Similarly, in Formula (1), examples of a cycloalkylene ring having 6 or more carbon atoms represented by A include a cyclohexane ring, and a cyclohexene ring. Among these, a cyclohexane ring (for example, cyclohexane-1,4-diyl group) is preferable.

Further, in Formula (1), examples of a polymerizable group represented by Q include a (meth)acryloyl group, a vinyl group, a styryl group, and an allyl group. The term “(meth)acryloyl group” refers to an acryloyl group or a methacryloyl group.

The liquid crystal compound represented by Formula (1) is preferably a compound having at least three ring structures selected from the group consisting of a benzene ring and a cyclohexane ring for the reason that smectic properties are easily exhibited by pseudo phase separation of the rigid mesogenic moiety and the flexible side chain and sufficient rigidity is exhibited.

In the present invention, as the liquid crystal compound represented by Formula (1), for the reason for further improving the durability of the optically anisotropic layer, a compound having two or more polymerizable groups (for example, (meth)acryloyl group, vinyl group, styryl group, and allyl group) is preferable.

In the present invention, since the polymerization rate is high and a dense optically anisotropic layer can be obtained, the polymerizable group of the liquid crystal compound is preferably a (meth)acryloyl group.

In the present invention, the liquid crystal compound is preferably a liquid crystal compound exhibiting reciprocal wavelength dispersion.

Herein, in this specification, the liquid crystal compound exhibiting “reciprocal wavelength dispersion” means that at the time of measurement of an in-plane retardation (Re) value at a specific wavelength (visible light range) of a phase difference film prepared using the liquid crystal compound, as the measurement wavelength increases, the Re value becomes equal or higher.

As the liquid crystal compound exhibiting reciprocal wavelength dispersion, Ar¹ in Formula (1) is preferably a compound which is a divalent aromatic ring group represented by Formula (II-1), (II-2), (II-3), or (II-4).

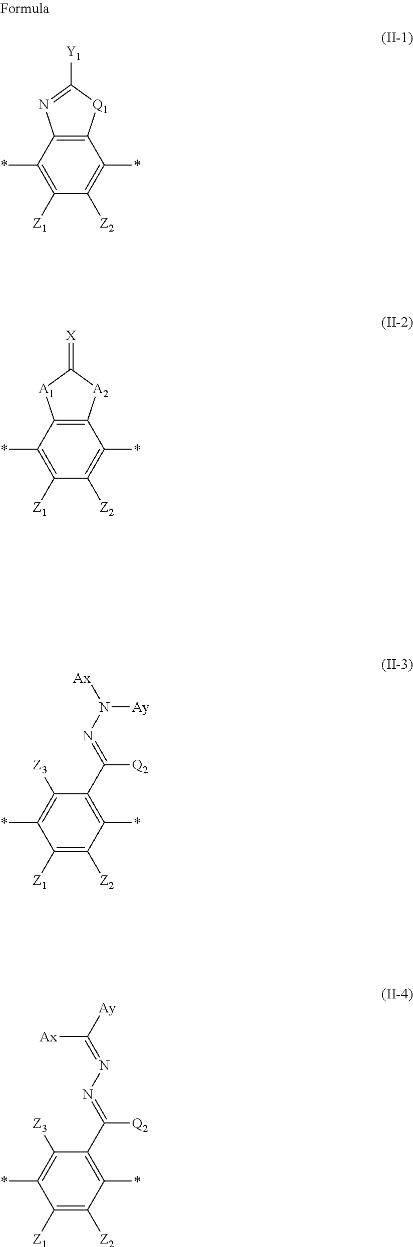

In Formulae (II-1) to (II-4), Q₁ represents —S—, —O—, or —NR¹¹—,

R¹¹ represents a hydrogen atom or an alkyl group having 1 to 6 carbon atoms,

Y₁ represents an aromatic hydrocarbon ring group having 6 to 12 carbon atoms or an aromatic heterocyclic group having 3 to 12 carbon atoms (where the aromatic hydrocarbon ring group and the aromatic heterocyclic group may have a substituent),

Z₁, Z₂, and Z₃ each independently represent a hydrogen atom, an aliphatic hydrocarbon group having 1 to 20 carbon atoms, an alicyclic hydrocarbon group having 3 to 20 carbon atoms, a monovalent aromatic hydrocarbon ring group having 6 to 20 carbon atoms, a halogen atom, a cyano group, a nitro group, —NR¹²R¹³, or —SR¹²,

Z₁ and Z₂ may be bonded to each other to form an aromatic ring or an aromatic heterocyclic ring, and R¹² and R¹³ each independently represent a hydrogen atom or an alkyl group having 1 to 6 carbon atoms,

A¹ and A² each independently represent a group selected from the group consisting of —O—, —NR²¹—, —S—, and —CO—, R²¹ represents a hydrogen atom or a substituent, X represents a hydrogen atom or a non-metal atom of Groups 14 to 16 to which a substituent may be bonded (preferably, ═O, ═S, ═NR′, and ═C(R′)R′ may be exemplified (where R′ represents a substituent)),

Ax represents an organic group having 2 to 30 carbon atoms and having at least one aromatic ring selected from the group consisting of an aromatic hydrocarbon ring and an aromatic heterocyclic ring, and preferably an aromatic hydrocarbon ring group; an aromatic heterocyclic ring group; an alkyl group having 3 to 20 carbon atoms and having at least one aromatic ring selected from the group consisting of an aromatic hydrocarbon ring and an aromatic heterocyclic ring; and an alkenyl group having 3 to 20 carbon atoms and having at least one aromatic ring selected from the group consisting of an aromatic hydrocarbon ring and an aromatic heterocyclic ring may be exemplified,

Ay represents a hydrogen atom, an alkyl group having 1 to 6 carbon atoms which may have a substituent, or an organic group having 2 to 30 carbon atoms and having at least one aromatic ring selected from the group consisting of an aromatic hydrocarbon ring and an aromatic heterocyclic ring, and a preferable aspect of the organic group is the same as the preferable aspect of the organic group of the Ax,

the aromatic ring in Ax and Ay may have a substituent respectively and Ax and Ay may be bonded to form a ring, and

Q₂ represents a hydrogen atom or an alkyl group having 1 to 6 carbon atoms which may have a substituent.

Examples of the substituent include a halogen atom, an alkyl group, a halogenated alkyl group, an alkenyl group, an aryl group, a cyano group, an amino group, a nitro group, a nitroso group, a carboxy group, an alkylsulfinyl group having 1 to 6 carbon atoms, an alkylsulfonyl group having 1 to 6 carbon atoms a fluoroalkyl group having 1 to 6 carbon atoms, an alkoxy group having 1 to 6 carbon atoms, an alkylsulfanyl group having 1 to 6 carbon atoms, an N-alkylamino group having 1 to 6 carbon atoms, an N,N-dialkylamino group having 2 to 12 carbon atoms, an N-alkylsulfamoyl group having 1 to 6 carbon atoms, and an N,N-dialkylsulfamoyl group having 2 to 12 carbon atoms.

Preferable examples of the liquid crystal compounds represented by Formulae (II-1) to (II-4) are shown below. However, the liquid crystal compounds are not limited to these liquid crystal compounds.

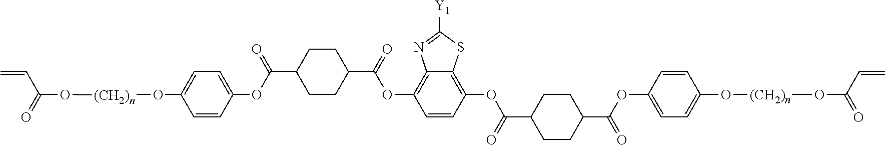

| No | Y₁ | n |
|---|---|---|
| II-1-1 | 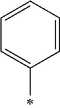 | 6 |
| II-1-2 | 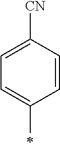 | 6 |
| II-1-3 | 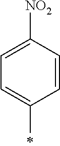 | 6 |
| II-1-4 | 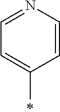 | 6 |
| II-1-5 | 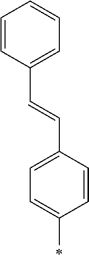 | 6 |
| II-1-6 | 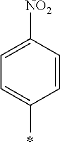 | 11 |
| II-1-7 | 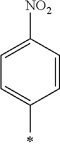 | 8 |
| II-1-8 | 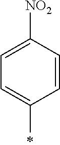 | 4 |
| II-1-9 | 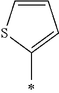 | 6 |
| I-1-10 | 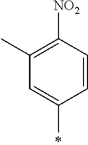 | 6 |
| I-1-11 | 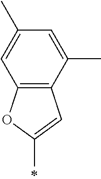 | 6 |
| II-1-12 | 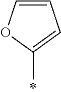 | 6 |
| II-1-13 | 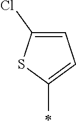 | 6 |
| II-1-14 | 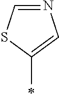 | 6 |
| II-1-15 | 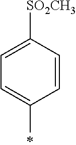 | 6 |

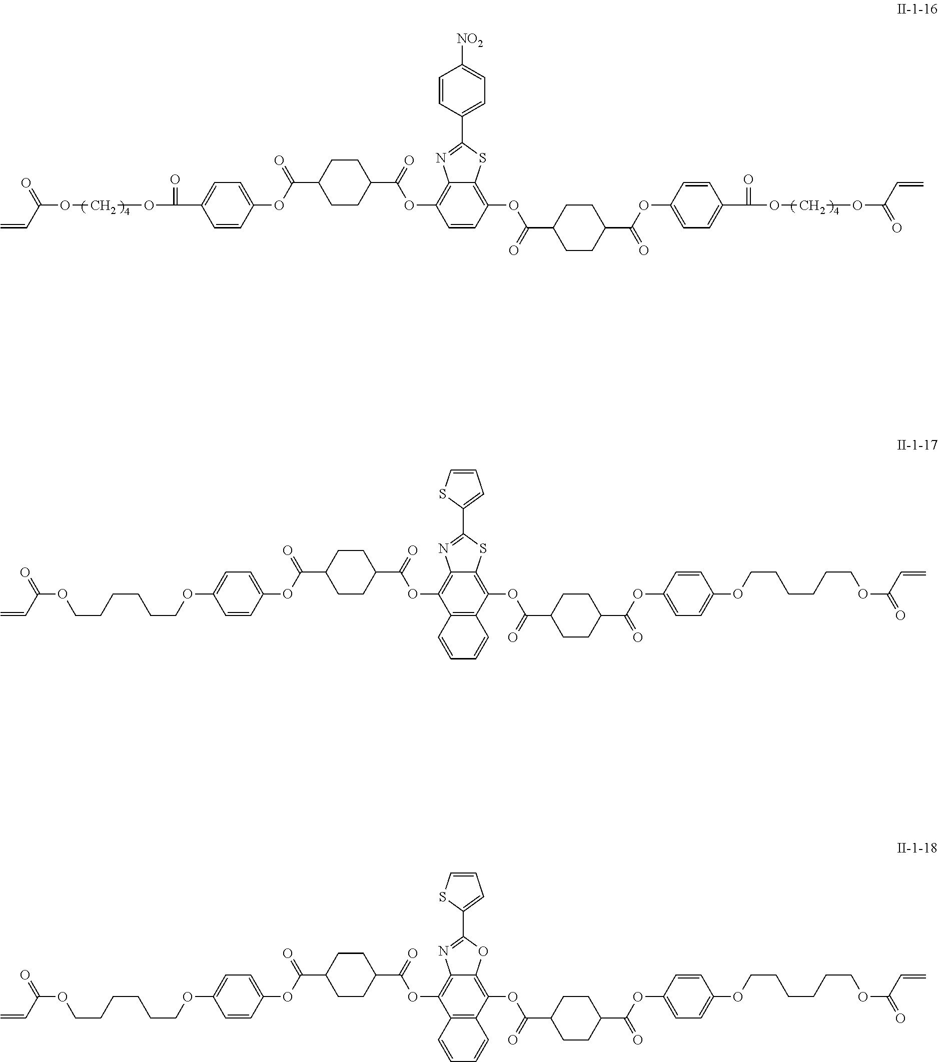

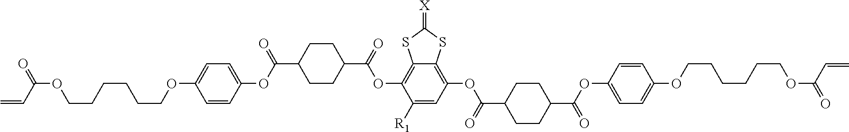

| No | X | R₁ |
|---|---|---|
| II-2-1 | 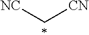 | H |
| II-2-2 | 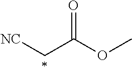 | H |
| II-2-3 | 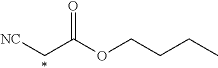 | H |
| II-2-4 | 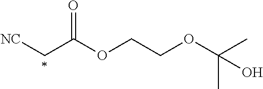 | H |
| II-2-5 | 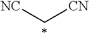 | CH₃ |
| II-2-6 | 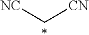 | 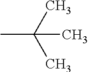 |
| II-2-7 | S | H |

In the formulae. “*” represents a bonding position.

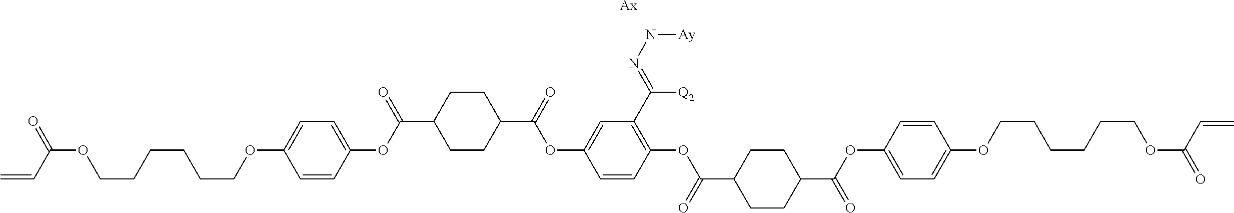

| No | Ax | Ay | Q₂ |
|---|---|---|---|
| II-3-1 | 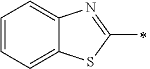 | H | H |
| II-3-2 | 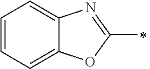 | H | H |
| II-3-3 | 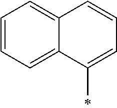 | H | H |
| II-3-4 | Ph | Ph | H |
| II-3-5 | 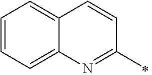 | H | H |
| II-3-6 | 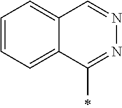 | H | H |
| II-3-7 | 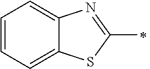 | CH₃ | H |
| II-3-8 | 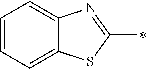 | C₄H₄ | H |
| II-3-9 | 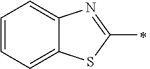 | C₆H₁₃ | H |
| II-3-10 | 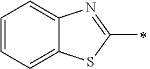 | 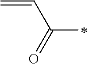 | H |
| II-3-11 | 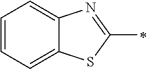 | 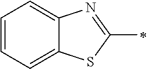 | H |
| II-3-12 | 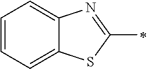 | CH₂CN | H |
| II-3-13 | 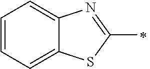 | 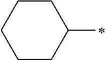 | H |
| II-3-14 | 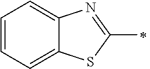 | 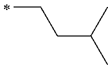 | H |
| II-3-15 | 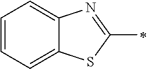 | CH₂CH₂OH | H |
| II-3-16 | 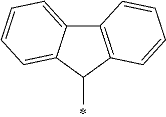 | H | H |
| II-3-17 | 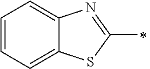 | CH₂CF₃ | H |
| II-3-18 | 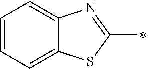 | H | CH₃ |
| II-3-19 | 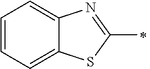 | 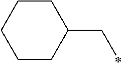 | H |
| II-3-20 | 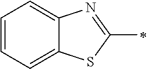 | 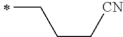 | H |
| II-3-21 | 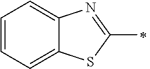 | 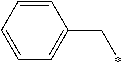 | H |
| II-3-22 | 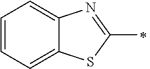 | 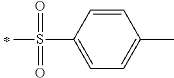 | H |
| II-3-23 | 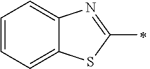 | 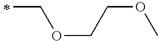 | H |
| II-3-24 | 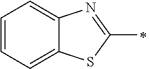 | 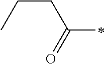 | H |
| II-3-25 | 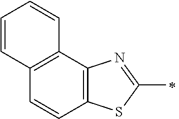 | C₆H₁₃ | H |

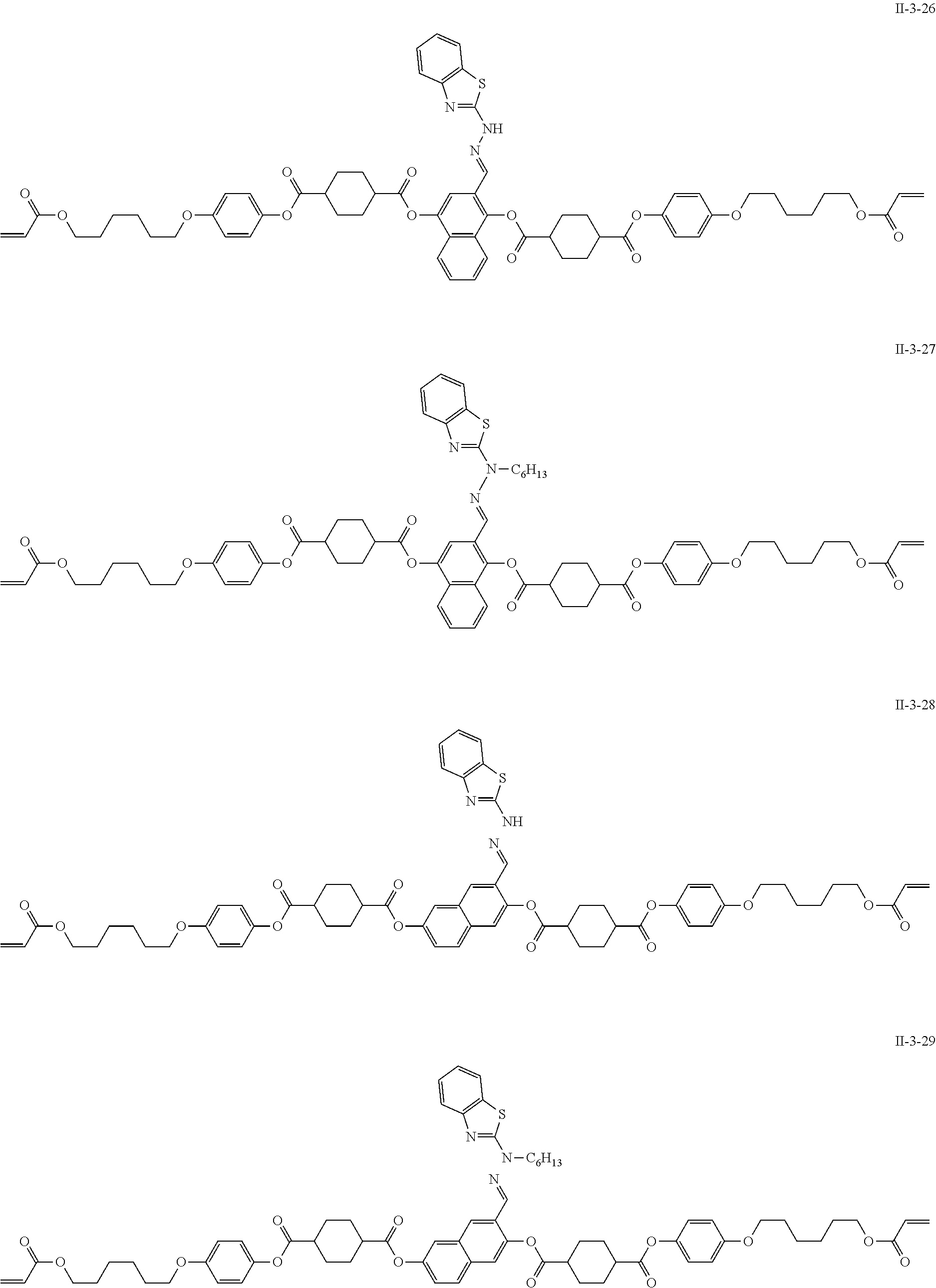

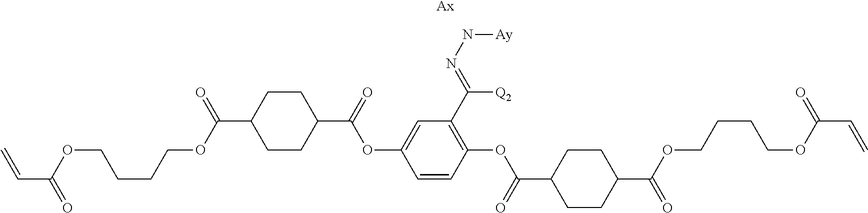

| No | Ax | Ay | Q2 |
|---|---|---|---|
| II-3-30 | 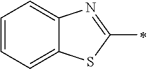 | H | H |
| II-3-31 | 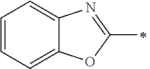 | H | H |
| II-3-32 | 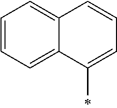 | H | H |
| II-3-33 | Ph | Ph | H |
| II-3-34 | 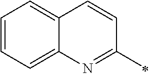 | H | H |
| II-3-35 | 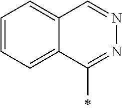 | H | H |
| II-3-36 | 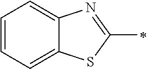 | CH₃ | H |
| II-3-37 | 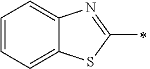 | C₄H₉ | H |
| II-3-38 | 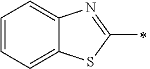 | C₆H₁₃ | H |
| II-3-39 | 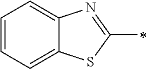 | 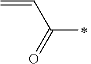 | H |
| II-3-40 | 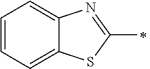 | 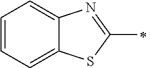 | H |
| II-3-41 | 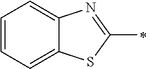 | CH₂CN | H |
| II-3-42 | 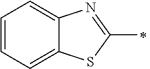 | 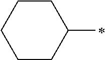 | H |
| II-3-43 | 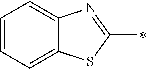 | 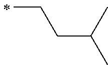 | H |
| II-3-46 | 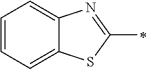 | CH₂CH₂OH | H |
| II-3-45 | 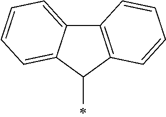 | H | H |
| II-3-46 | 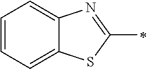 | CH₂CH₂OH | H |
| II-3-47 | 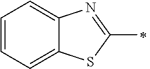 | H | CH₃ |
| II-3-48 | 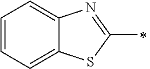 | 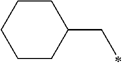 | H |
| II-3-49 | 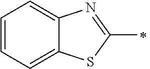 | 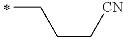 | H |
| II-3-50 | 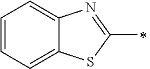 | 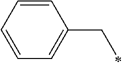 | H |
| II-3-51 | 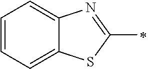 | 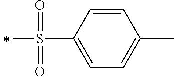 | H |
| II-3-52 | 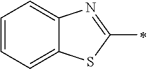 | 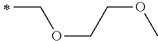 | H |
| II-3-53 | 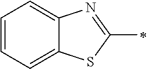 | 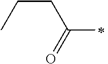 | H |
| II-3-54 | 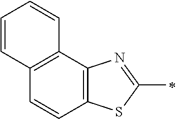 | C₆H₁₃ | H |

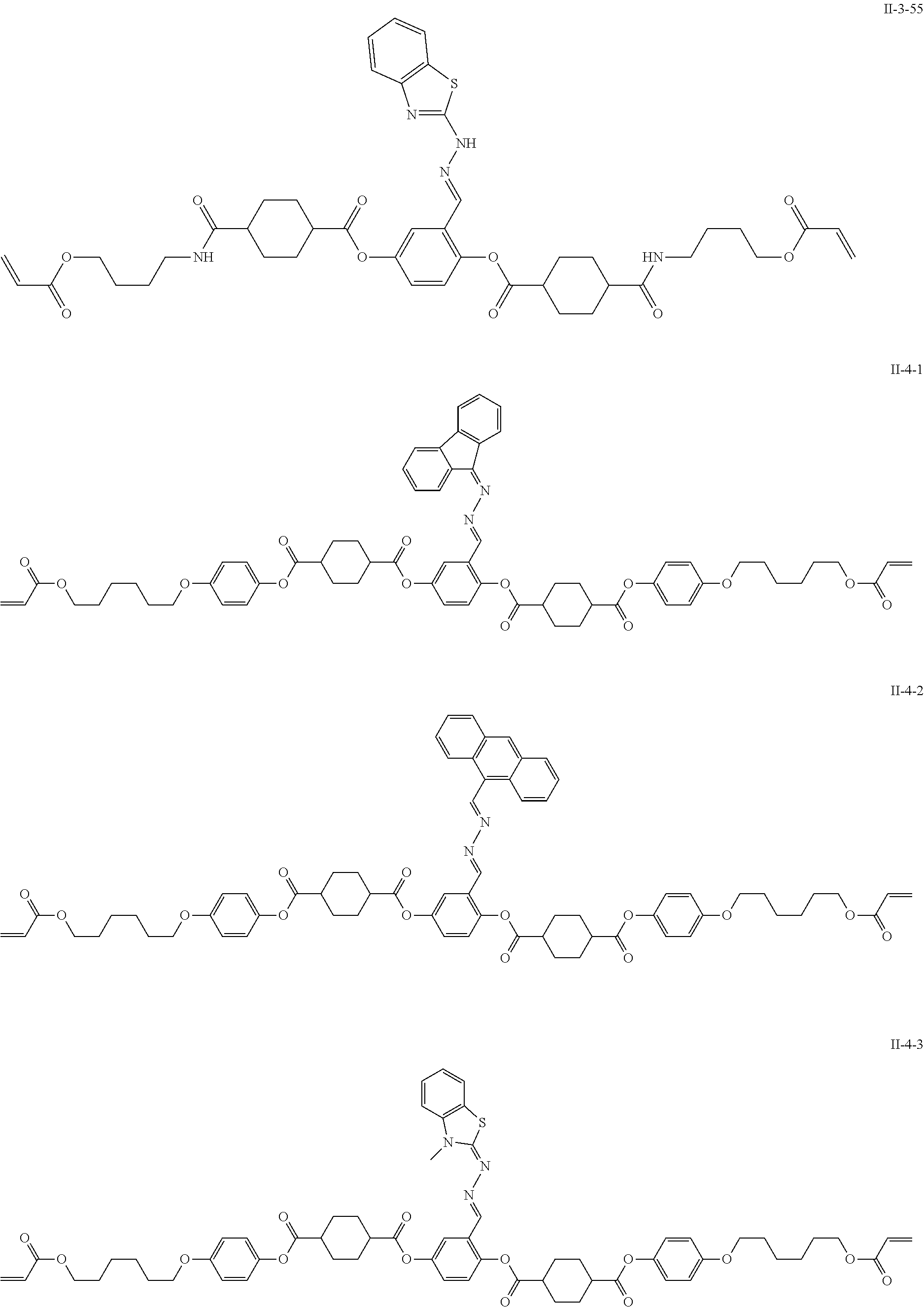

Further, in the present invention, as the liquid crystal compound represented by Formula (1), for the reason for further improving the durability of the optically anisotropic layer by electronic interaction between liquid crystal molecules, Ar¹ in Formula (1) is preferably a compound represented by Formula (II-2). Specifically, it is more preferable that n in Formula (1) is 2 and Ar¹ is a compound represented by Formula (1a).

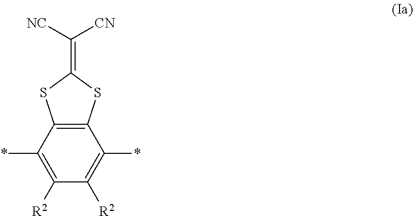

Herein, in Formula (1a), * represents a bonding position, and R²'s each independently represent a hydrogen atom or an alkyl group having 1 to 6 carbon atoms.

Examples of a compound in which n in Formula (1) is 2 and Ar¹ is a compound represented by Formula (1a) include a compound represented by Formula L-1 (liquid crystal compound L-1), a compound represented by Formula L-2 (liquid crystal compound L-2), a compound represented by Formula L-5 (liquid crystal compound L-5), and a compound represented by Formula L-6 (liquid crystal compound L-6). A group adjacent to an acryloyl oxy group in Formulae L-1 and L-2 represents a propylene group (a group in which a methyl group is substituted with an ethylene group), and the liquid crystal compounds L-1 and L-2 represent mixtures of positional isomers in which the positions of methyl group are different.

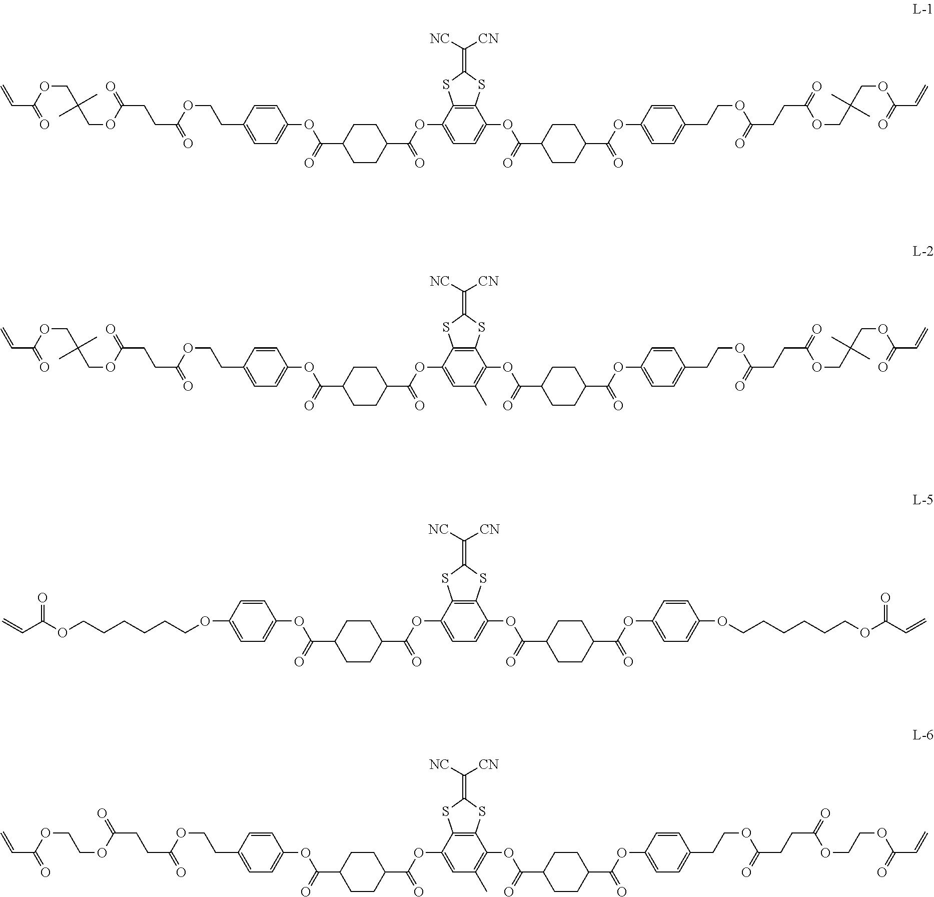

<Polymerization Initiator>

The polymerizable liquid crystal composition forming the optically anisotropic layer includes a polymerization initiator.

The polymerization initiator to be used is preferably a photopolymerization initiator that can initiate a polymerization reaction by irradiation with ultraviolet rays.

Examples of the photopolymerization initiator include α-carbonyl compounds (described in U.S. Pat. No. 2,367,661A and U.S. Pat. No. 2,367,670A), acyloin ethers (described in U.S. Pat. No. 2,448,828A), α-hydrocarbon-substituted aromatic acyloin compounds (described in U.S. Pat. No. 2,722,512A), multinuclear quinone compounds (as described in U.S. Pat. No. 3,046,127A and U.S. Pat. No. 2,951,758A), combinations of triarylimidazole dimer and p-aminophenyl ketone (as described in U.S. Pat. No. 3,549,367A), acridine and phenazine compounds (described in JP1985-105667A (JP-S60-105667A) and U.S. Pat. No. 4,239,850A), oxadiazole compounds (described in U.S. Pat. No. 4,212,970A), and acyl phosphine oxide compounds (described in JP1988-40799B (JP-S63-40799B), JP1993-29234B (JP-H05-29234B), JP1998-95788A (JP-H10-95788A), and JP1998-29997A (JP-H10-29997A)).

In the present invention, for the reason for further improving the durability of the optically anisotropic layer, the polymerization initiator is preferably an oxime type polymerization initiator, and specifically, the polymerization initiator is more preferably an oxime type polymerization initiator represented by Formula (2).

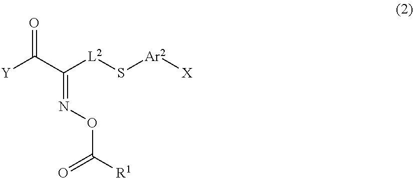

Herein, in Formula (2), X represents a hydrogen atom or a halogen atom,

Ar² represents a divalent aromatic group, L² represents a divalent organic group having 1 to 12 carbon atoms, and

R¹ represents an alkyl group having 1 to 12 carbon atoms, and Y represents a monovalent organic group.

In Formula (2), examples of the halogen atom represented by X include a fluorine atom, a chlorine atom, a bromine atom, and an iodine atom, and among them, a chlorine atom is preferable.

In addition, as the divalent aromatic group represented by Ar² in Formula (2), a divalent group having at least one aromatic ring selected from the group consisting of the aromatic hydrocarbon ring and the aromatic heterocyclic ring exemplified as Ar¹ in Formula (1) may be used.

In addition, examples of the divalent organic group in Formula (2), having 1 to 12 carbon atoms represented by L² include a linear or branched alkylene group having 1 to 12 carbon atoms. Specifically, a methylene group, an ethylene group, a propylene group, and the like may be suitably used.

In addition, in Formula (2), specifically suitable examples of the alkyl group having 1 to 12 carbon atoms represented by R¹ includes a methyl group, an ethyl group, and a propyl group.

Further, in Formula (2), examples of the monovalent organic group represented by Y include functional groups including a benzophenone skeleton ((C₆H₅)₂CO). Specifically, like the groups represented by Formulae (2a) and (2b), functional groups including a benzophenone skeleton in which a benzene ring at the terminal is unsubstituted or has one substituent are preferable.

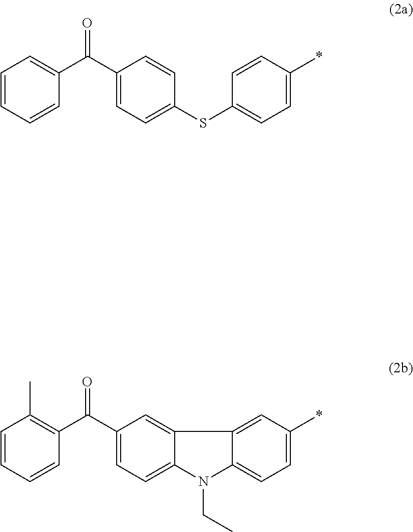 [SMILES: *c1ccc(Sc2ccc(C(=O)c3ccccc3)cc2)cc1 ; *c1ccc2c(c1)c1cc(C(=O)c3ccccc3C)ccc1n2CC]

Herein, in Formulae (2a) and (2b), * represents a bonding position, that is, a bonding position with the carbon atom of the carbonyl group in Formula (2).

Examples of the oxime type polymerization initiator represented by Formula (2) include a compound represented by Formula S-1 and a compound represented by Formula S-2.

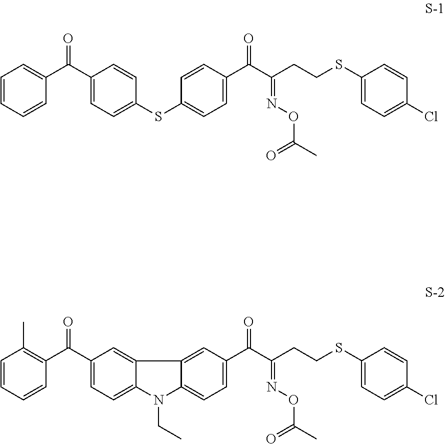 [SMILES: CC(=O)O/N=C(\CCSc1ccc(Cl)cc1)C(=O)c1ccc(Sc2ccc(C(=O)c3ccccc3)cc2)cc1 ; CCn1c2ccc(C(=O)/C(CCSc3ccc(Cl)cc3)=N/OC(C)=O)cc2c2cc(C(=O)c3ccccc3C)ccc21]

In the present invention, the content of the polymerization initiator is not particularly limited. However, the solid content of the polymerizable liquid crystal composition is preferably 0.01% to 20% by mass and more preferably 0.5% to 5% by mass.

<Organic Solvent>

The polymerizable liquid crystal composition forming the optically anisotropic layer preferably contains an organic solvent from the viewpoint of workability for forming the optically anisotropic layer and the like.

Specific examples of the organic solvent include ketones (such as acetone, 2-butanone, methyl isobutyl ketone, and cyclohexanone), ethers (such as dioxane and tetrahydrofuran), aliphatic hydrocarbons (such as hexane), alicyclic hydrocarbons (such as cyclohexane), aromatic hydrocarbons (such as toluene, xylene, and trimethylbenzene), halogenated carbons (such as dichloromethane, dichloroethane, dichlorobenzene, and chlorotoluene), esters (such as methyl acetate, ethyl acetate, and butyl acetate), water, alcohols (such as ethanol, isopropanol, butanol, and cyclohexanol), cellosolves (such as methyl cellosolve and ethyl cellosolve), cellosolve acetates, sulfoxides (such as dimethyl sulfoxide), and amides (such as dimethylformamide and dimethylacetamide). These may be used alone or may be used in combination of two or more kinds.

In the present invention, as the method of forming the optically anisotropic layer, for example, a method in which a desired alignment state is obtained using the polymerizable liquid crystal composition containing an arbitrary organic solvent in addition to the above-described liquid crystal compound and polymerization initiator and then the alignment state is fixed by polymerization, and the like may be used.

Herein, the polymerization conditions are not particularly limited and in the polymerization by photoirradiation, ultraviolet (UV) rays are preferably used. The irradiation dose is preferably 10 mJ/cm² to 50 J/cm², more preferably 20 mJ/cm² to 5 J/cm², still more preferably 30 mJ/cm² to 3 J/cm², and particularly preferably 50 to 1,000 mJ/cm². In addition, in order to promote the polymerization reaction, the polymerization may be carried out under a heating condition.

In the present invention, the optically anisotropic layer can be formed on an arbitrary support described later or a polarizer of a polarizing plate of the present invention described later.

In addition, in the present invention, for the reason for improving the contrast of an image display device, the optically anisotropic layer is preferably a layer that can be obtained by aligning the above-described polymerizable liquid crystal composition in a smectic phase and then polymerizing (fixing the alignment) the compound. It is considered that this is because the degree of order of the smectic phase is higher than that of a nematic phase and scattering caused by the alignment disorder of the optically anisotropic layer is suppressed.

In addition, the optically anisotropic layer of the optical film of the present invention preferably satisfies Expression (I) from the viewpoint of imparting excellent viewing angle properties.

0.75≤Re(450)/Re(550)≤1.00 (I)

Herein, in Expression (I), Re(450) represents an in-plane retardation of the optically anisotropic layer at a wavelength of 450 nm, and Re(550) represents an in-plane retardation of the optically anisotropic layer at a wavelength of 550 nm.

In addition, the in-plane retardation value refers a value measured with light at the measurement wavelength using an automatic birefringence meter (KOBRA-21ADH, manufactured by Oji Scientific Instruments).

In the present invention, although the thickness of the optically anisotropic layer is not particularly limited, the thickness thereof is preferably 0.1 to 10 μm and more preferably 0.5 to 5 μm.

[Overcoat Layer]

The overcoat layer of the optical film of the present invention is a layer obtained by curing a polyfunctional polymerizable monomer having two or more polymerizable groups and the molecular weight per polymerizable group in the polyfunctional polymerizable monomer is 140 or less.

In the present invention, as described above, it is considered that by providing the overcoat layer obtained by curing the polyfunctional polymerizable monomer having a molecular weight per polymerizable group of 140 or less, a low molecular compound remaining in the optically anisotropic layer can be prevented from being transferred to the pressure sensitive adhesive layer.

In addition, in the present invention, for the reason for further improving the durability of the optically anisotropic layer, the molecular weight per polymerizable group in the polyfunctional polymerizable monomer is preferably 90 to 135.

In the present invention, for the reason for further improving the durability of the optically anisotropic layer, it is preferable that the overcoat layer is a layer having no glass transition temperature or a layer having a glass transition temperature of 80° C. or higher.

Here, the glass transition temperature refers to temperature measured by the following manner. Specifically, 20 mg of a sample of the overcoat layer is placed in a measurement pan of a differential scanning calorimeter (X-DSC7000 (manufactured by IT Keisoku Seigyo Co.)), is heated from 30° C. to 120° C. at a rate of 10° C./min in a nitrogen stream and held for 15 minutes, and then cooled from 30° C. at a rate of −20° C./min. Then, the temperature was again raised from 30° C. to 250° C. and temperature at which the base line starts to deviate from the low temperature side is set to glass transition temperature (Tg).

In addition, the expression “having no glass transition temperature” refers that glass transition temperature is not observed by the above-described measurement method.

Specific examples of the polymerizable group of the polyfunctional polymerizable monomer include a (meth)acryloyl group, a vinyl group, a styryl group, and an allyl group, and among these, a (meth)acryloyl group is preferable.

Specific examples of polyfunctional polymerizable monomers having an acryloyl group include bis(4-acryloxypolyethoxyphenyl)propane, tripropylene glycol diacrylate, polyethylene glycol diacrylate, polypropylene glycol diacrylate, pentaerythritol tetraacrylate, dipentaerythritol tetraacrylate, trimethylolpropane (propylene oxide modified) triacrylate, oligoester acrylate, neopentyl glycol hydroxypivalate diacrylate, tetramethylol methane triacrylate, dimethyloltricyclodecane diacrylate, modified glycerin triacrylate, bisphenol A diglycidyl ether acrylic acid adduct, modified bisphenol A diacrylate, propylene oxide (PO) adducted bisphenol A diacrylate, ethylene oxide (EO) adducted bisphenol A diacrylate, dipentaerythritol hexaacrylate, propylene glycol diglycidyl ether acrylic acid adduct, ditrimethylolpropane tetraacrylate, 1,9-nonanediol diacrylate, and propoxy-modified neopentyl glycol diacrylate.

Specific examples of polyfunctional polymerizable monomers having a methacryloyl group include polyethylene glycol dimethacrylate, polypropylene glycol dimethacrylate, and 2,2-bis(4-methacryloxypolyethoxyphenyl)propane.

Other examples of the polyfunctional polymerizable monomers include allyl compounds such as diallyl phthalate and triallyltrimellitate.

As other examples of the polyfunctional polymerizable monomers, commercially available products or known products of radically polymerizable and crosslinkable monomers in the art, such as those described in Shinzo Yamashita Ed., “Crosslinking Agent Handbook” (1981, Taisei Publishing); Kiyoshi Kato Ed., “UV⋅EB Curing Handbook (Raw Material)” (1985, Kobunshi Kankokai); RadTech Japan Ed., “Application and Market of UV⋅EB Curing Technology”, p. 79, (1989, CMC); Eiichiro Takiyama, “Polyester Resin Handbook” (1988, Nikkankogyo Shimbun); and the like, can also be used.

In the present invention, among the polyfunctional polymerizable monomer described above, a polyfunctional polymerizable monomer in which the molecular weight per polymerizable group (hereinafter, in the paragraph, abbreviated as “Mw/C═C”) is 140 or less is used. Examples of commercially available products other than the commercially available products used in examples described later include EBECRYL 5129 (molecular weight: 800, Mw/C═C: 133) or KRM 8452 (molecular weight: 1200, Mw/C═C: 120) manufactured by DAICEL-ALLNEX LTD., and VISCOAT #802 (molecular weight: 805, Mw/C═C: 101) manufactured by Osaka Organic Chemical Industry Ltd.

In the present invention, the method of forming the overcoat layer is not particularly limited and for example, the overcoat layer can be formed by applying a composition containing a polymerization initiator and an organic solvent in addition to the above-described polyfunctional polymerizable monomer to the above-described optically anisotropic layer and curing the composition.

Here, examples of the polymerization initiator and the organic solvent include the same polymerization initiators and organic solvents as those described in the polymerizable liquid crystal composition of the above-described optically anisotropic layer.

In addition, as the coating method, a screen printing method, a dip coating method, a spray coating method, a spin coating method, an ink jet method, a gravure offset printing method, and a flexographic printing method.

The curing method is not particularly limited and ultraviolet (UV) rays are preferably used in the polymerization by photoirradiation as in a case of the above-described optically anisotropic layer. The irradiation dose is preferably 10 mJ/cm² to 50 J/cm², more preferably 20 mJ/cm² to 5 J/cm², still more preferably 30 mJ/cm² to 3 J/cm², and particularly preferably 50 to 1,000 mJ/cm².

In the present invention, the thickness of the overcoat layer is not particularly limited but the thickness thereof is preferably 0.5 to 50 μm, more preferably 1 to 50 μm, and still more preferably 3 to 20 μm.

[Pressure Sensitive Adhesive Layer]

The pressure sensitive adhesive layer of the optical film of the present invention is not particularly limited and a known pressure sensitive adhesive layer in the related art for bonding a polarizing plate and a display element such as a liquid crystal cell can be used.

Examples of the pressure sensitive adhesive layer include a substance in which a ratio between storage elastic modulus G′ and loss elastic modulus G″ (tan δ=G″/G′) is 0.001 to 1.5, where G′ and G″ are measured with a dynamic viscoelastometer, that is, a so-called pressure sensitive adhesive and a readily creepable substance.

As the pressure sensitive adhesive that can be used for the pressure sensitive adhesive layer, for example, a rubber-based pressure sensitive adhesive, an acrylic pressure sensitive adhesive, a silicone-based pressure sensitive adhesive, a urethane-based pressure sensitive adhesive, a vinyl alkyl ether-based pressure sensitive adhesive, a polyvinyl alcohol-based pressure sensitive adhesive, a polyvinylpyrrolidone-based pressure sensitive adhesive, a polyacrylamide-based pressure sensitive adhesive, and a cellulose-based pressure sensitive adhesive.

In the present invention, from the viewpoint of peeling property in reworking process, the glass transition temperature of the pressure sensitive adhesive layer is preferably −100° C. to 25° C. and more preferably −50° C. to 0° C.

In the present invention, the thickness of the pressure sensitive adhesive layer is not particularly limited and is preferably 10% to 50% of the entire thickness of the optical film and more preferably 20% to 40% of the entire thickness of the optical film.

[Polarizing Plate]

A polarizing plate of the present invention has the above-described optical film of the present invention and a polarizer.

FIG. 2 is a cross-sectional view schematically chowing an example of the polarizing plate of the present invention.

A polarizing plate 20 shown in FIG. 2 includes a polarizer 22, an optically anisotropic layer 12, an overcoat layer 14, and a pressure sensitive adhesive layer 16 in this order.

The polarizing plate of the present invention may have a support and an alignment film not shown in FIG. 2 between the polarizer 22 and the optically anisotropic layer 12 or may have a polarizer protective film on a surface of the polarizer 22 on the opposite side of the optically anisotropic layer 12.

Hereinafter, various members used in the polarizing plate of the present invention will be described in detail.

[Polarizer]

The polarizer of the polarizing plate of the present invention is not particularly limited as long as the polarizer is a member having a function of converting light into specific linearly polarized light, and conventionally known absorptive type polarizer and reflective type polarizer can be used.

An iodine-based polarizer, a dye-based polarizer using a dichroic dye, a polyene-based polarizer, and the like are used as the absorptive type polarizer. The iodine-based polarizer and the dye-based polarizer are a coating type polarizer and a stretching type polarizer, any one of these polarizers can be applied. However, a polarizer which is prepared by allowing polyvinyl alcohol to adsorb iodine or a dichroic dye and performing stretching is preferable.

In addition, examples of a method of obtaining a polarizer by performing stretching and dyeing in a state of a laminated film in which a polyvinyl alcohol layer is formed on a substrate include methods disclosed in JP5048120B, JP5143918B, JP4691205B, JP4751481B, and JP4751486B, and known technologies related to these polarizers can be preferably used.

A polarizer in which thin films having different birefringence are laminated, a wire grid type polarizer, a polarizer in which a cholesteric liquid crystal having a selective reflection range and a ¼ wavelength plate are combined, and the like are used as the reflective type polarizer.

Among these, a polarizer containing a polyvinyl alcohol-based resin (a polymer including —CH₂—CHOH— as a repeating unit, in particular, at least one selected from the group consisting of polyvinyl alcohol and an ethylene-vinyl alcohol copolymer) is preferable.

In the present invention, although the thickness of the polarizer is not particularly limited, the thickness thereof is preferably 3 μm to 60 μm, more preferably 5 μm to 30 μm, and still more preferably 5 μm to 15 μm.

[Support]

The polarizing plate of the present invention may have a support as a substrate for forming the optically anisotropic layer as described above.

Such a support is preferably transparent and specifically, the support preferably has a light transmittance of 80% or more.

Examples of such a support include glass substrates and polymer films. Examples of the material for the polymer film include cellulose-based polymers; acrylic polymers having acrylic ester polymers such as polymethyl methacrylate, and lactone ring-containing polymers; thermoplastic norbornene-based polymers; polycarbonate-based polymers; polyester-based polymers such as polyethylene terephthalate and polyethylene naphthalate; styrene-based polymers such as polystyrene and acrylonitrile-styrene copolymers (AS resin); polyolefin-based polymers such as polyethylene, polypropylene, and ethylene-propylene copolymers; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers containing a mixture of these polymers.

In addition, the polarizer described above may function as such a support.

In the present invention, although the thickness of the support is not particularly limited, the thickness thereof is preferably 5 to 60 μm and more preferably 5 to 30 μm.

[Alignment Film]

In the case in which the polarizing plate has the above-described arbitrary support, the polarizing plate of the present invention preferably has an alignment film between the support and the optically anisotropic layer. The above-described support may function as an alignment film.

The alignment film generally has a polymer as a main component. The materials for the polymer material for an alignment film are described in many documents and many commercially available products can be used.

The polymer material used in the present invention is preferably a polyvinyl alcohol, or a polyimide, or a derivative thereof. Particularly, a modified or non-modified polyvinyl alcohol is preferable.

Examples of alignment films that can be used in the present invention include alignment films described in Line 24 on Page 43 to Line 8 on Page 49 of WO01/88574A; modified polyvinyl alcohols described in paragraphs [0071] to [0095] of JP3907735B; and a liquid crystal alignment film formed by a liquid crystal aligning agent described in JP2012-155308A.

In the present invention, for the reason that surface state deterioration can be prevented by avoiding a contact with the surface of the alignment film at the time of forming the alignment film, an optical alignment film is preferably used as the alignment film.

Although the optical alignment film is not particularly limited, polymer materials such as polyamide compounds and polyimide compounds described in paragraphs [0024] to [0043] of WO2005/096041A; a liquid crystal alignment film formed by a liquid crystal aligning agent having a photo-aligned group described in JP2012-155308A; and LPP-JP265CP, product name, manufactured by Rolic technologies Ltd. can be used.

In addition, in the present invention, although the thickness of the alignment film is not particularly limited, from the viewpoint of forming an optically anisotropic layer having a uniform film thickness by alleviating the surface roughness present on the support, the thickness thereof is preferably 0.01 to 10 μm, more preferably 0.01 to 1 μm, and still more preferably 0.01 to 0.5 μm.

[Polarizer Protective Film]

The polarizing plate of the present invention may have a polarizer protective film for protecting the polarizer.

The configuration of the polarizer protective film is not particularly limited and the polarizer protective film may be, for example, a so-called transparent support, a hard coat layer, or a laminate of a transparent support and a hard coat layer.

As the hard coat layer, layers described in paragraphs [0190] to [0196] of JP2009-98658A can be used.

As the transparent support, a known transparent support can be used and for example, as the material for forming the transparent support, a cellulose-based polymer (hereinafter, referred to as cellulose acylate) typified as triacetyl cellulose and a thermoplastic norborene-based resin (ZEONEX and ZEONOR, manufactured by Zeon Corporation, ARTON, manufactured by JSR Corporation, or the like), an acrylic resin, and a polyester-based resin can be used.

Although the thickness of the polarizer protective film is not particularly limited, the thickness thereof is preferably 40 μm or less and more preferably 25 μm or less since the thickness of the polarizing plate can be reduced.

[Ultraviolet Absorbent]

The polarizing plate of the present invention preferably includes an ultraviolet (UV) absorbent in consideration of effect of external light (particularly, ultraviolet rays) and more preferably includes an ultraviolet absorbent in the support.

As the ultraviolet absorbent, any of known ultraviolet absorbents can be used since ultraviolet absorbency can be exhibited. Among these ultraviolet absorbents, in order to obtain a high ultraviolet absorbency and ultraviolet absorptivity (ultraviolet cutting ability) used for an electronic image display device, a benzotriazole-based or hydroxyphenyl triazine-based ultraviolet absorbent is preferable. In addition, in order to widen the ultraviolet absorption width, two or more kinds of ultraviolet absorbents having different maximum absorption wavelengths can be used in combination.

[Image Display Device]

An image display device of the present invention is an image display device having the optical film of the present invention or the polarizing plate of the present invention.

The display element used for the image display device of the present invention is not particularly limited and examples thereof include a liquid crystal cell, an organic EL display panel, and a plasma display panel.

Among these, a liquid crystal cell and an organic EL display panel are preferable. That is, for the image display device of the present invention, a liquid crystal display device using a liquid crystal cell as a display element, and an organic EL display device using an organic EL display panel as a display element are preferable.

[Liquid Crystal Display Device]

A liquid crystal display device as an example of the image display device of the present invention is a liquid crystal display device including the above-described optical film or polarizing plate of the present invention and a liquid crystal cell.

FIG. 3 is a cross-sectional view schematically showing an example (liquid crystal display device) of an image display device of the present invention.

A liquid crystal display device 30 shown in FIG. 3 includes a polarizer 22, an optically anisotropic layer 12, an overcoat layer 14, a pressure sensitive adhesive layer 16, and a liquid crystal cell 32 in this order.

Hereinafter, the liquid crystal cell constituting the liquid crystal display device will be described in detail.

<Liquid Crystal Cell>

The liquid crystal cell for use in the liquid crystal display device is preferably of a vertical alignment (VA) mode, an optically compensated bend (OCB) mode, an in-plane-switching (IPS) mode or a twisted nematic (TN) mode but the cell mode is not limited thereto.

In a TN mode liquid crystal cell, rod-like liquid crystal molecules are aligned substantially horizontally in a case in which no voltage is applied and are further aligned in a twisted manner in a range of 60° to 120°. The TN mode liquid crystal cell is most often used in a color TFT liquid crystal display device and is mentioned in many literatures.

In a VA mode liquid crystal cell, rod-like liquid crystal molecules are aligned substantially vertically in a case in which no voltage is applied. Examples of the VA mode liquid crystal cells include (1) a narrowly defined VA mode liquid crystal cell (described in JP1990-176625A (JP-H02-176625A)) in which rod-like liquid crystal molecules are aligned substantially vertically in a case in which no voltage is applied and are aligned substantially horizontally in a case in which a voltage is applied, (2) a multi-domain VA mode (MVA mode) liquid crystal cell for enlarging the viewing angle (SID97, Digest of Tech. Papers (Proceedings) 28 (1997) 845), (3) a liquid crystal cell in a mode (n-ASM mode) in which rod-like liquid crystal molecules are aligned substantially vertically in a case in which no voltage is applied and are aligned in twisted multi-domain alignment in a case in which a voltage is applied (Proceedings of Japanese Liquid Crystal Conference, 58 and 59 (1998)), and (4) a SURVIVAL mode liquid crystal cell (presented in LCD International 98). The liquid crystal cell may be of any of a patterned vertical alignment (PVA) type, an optical alignment type, and a polymer-sustained alignment (PSA) type. These modes are described in detail in JP2006-215326A and JP2008-538819A.

In an IPS mode liquid crystal cell, rod-like liquid crystal molecules are aligned substantially parallel with respect to a substrate and application of an electric field parallel to the substrate surface causes the liquid crystal molecules to respond planarly. The IPS mode displays black in a case in which no electric field is applied and a pair of upper and lower polarizing plates have absorption axes which are orthogonal to each other. A method of improving the viewing angle by reducing light leakage during black display in an oblique direction using an optical compensation sheet is described in JP1998-54982A (JP-H10-54982A), JP1999-202323A (JP-H11-202323A), JP1997-292522A (JP-H09-292522A), JP1999-133408A (JP-H11-133408A), JP1999-305217A (JP-H11-305217A), JP1998-307291A (JP-H10-307291A), and the like.

[Organic EL Display Device]

An organic EL display device which is an example of the image display device of the present invention is a liquid crystal display device having the above-described optical film or polarizing plate of the present invention and an organic EL panel.

FIG. 4 is a cross-sectional view schematically showing an example (organic EL display device) of the image display device of the present invention.

An organic EL display device 40 shown in FIG. 4 includes a polarizer 22, an optically anisotropic layer 12, an overcoat layer 14, a pressure sensitive adhesive layer 16, and an organic EL panel 42 in this order.

As the organic EL display device, for example, an embodiment which includes, from the visible side, the polarizing plate of the present invention, a plate having a λ/4 function (hereinafter referred to also as “λ/4 plate”) and an organic EL display panel in this order is suitable.

The “plate having a λ/4 function” as used herein refers to a plate having a function of converting linearly polarized light at a specific wavelength into circularly polarized light (or circularly polarized light into linearly polarized light). Specific examples of an embodiment in which the λ/4 plate is of a single layer structure include a stretched polymer film, and a phase difference film in which an optically anisotropic layer having a λ/4 function is provided on a support. A specific example of an embodiment in which the λ/4 plate is of a multilayer structure includes a broadband λ/4 plate in which the λ/4 plate and a λ/2 plate are laminated on each other.

The organic EL display panel is a display panel configured using an organic EL element in which an organic light emitting layer (organic electroluminescent layer) is sandwiched between electrodes (between a cathode and an anode). The configuration of the organic EL display panel is not particularly limited but any known configuration is adopted.

### EXAMPLES

The present invention will be described below in further detail based on examples. The materials, amounts used, ratios, treatments and treatment procedures shown in the examples below can be modified as appropriate in the range of not departing from the spirit of the present invention. Therefore, the scope of the present invention should not be construed as being limited to the following examples.

### Example 1

<Formation of Polyvinyl Alcohol (PVA) Alignment Film P-1>

A 2% by weight aqueous solution of polyvinyl alcohol (polyvinyl alcohol 1000 (fully saponified), manufactured by Wako Pure Chemical Industries, Ltd.) was applied to a glass substrate and then heated and dried to obtain a PVA alignment film P-1 having a thickness of 89 nm.

<Formation of Optically Anisotropic Layer 1>

A surface of the obtained PVA alignment film P-1 was subjected to rubbing treatment and then a coating solution 1 for an optically anisotropic layer having the following composition was applied to the rubbed surface by a spin coating method to form a liquid crystal composition layer 1.

The formed liquid crystal composition layer 1 was once heated on a hot plate until a nematic phase (Ne phase) was obtained and then cooled to 60° C. to stabilize the alignment in a smectic A phase (SmA phase).

Then, while the temperature was kept at 60° C., the layer was irradiated with ultraviolet rays to fix the alignment. Thus, an optically anisotropic layer 1 having a thickness of 2 μm was formed.

Coating Solution 1 for Optically Anisotropic Layer

| | |
|---|---|
| Liquid crystal compound L-1 shown below | 46.50 parts by mass |
| Liquid crystal compound L-2 shown below | 46.50 parts by mass |
| Liquid crystal compound A-1 shown below | 7.00 parts by mass |
| Polymerization initiator S-1 shown below (oxime type) | 3.00 parts by mass |
| Leveling agent (Compound T-1 shown below) | 0.20 parts by mass |
| Methyl ethyl ketone | 219.30 parts by mass |

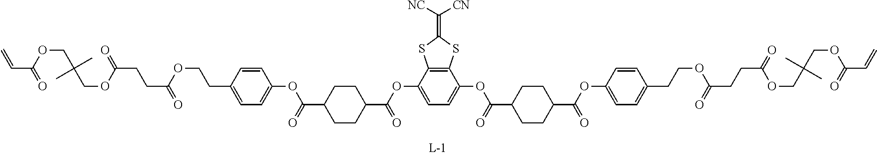 [SMILES: C=CC(=O)OCC(C)(C)COC(=O)CCC(=O)OCCc1ccc(OC(=O)C2CCC(C(=O)Oc3ccc(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]

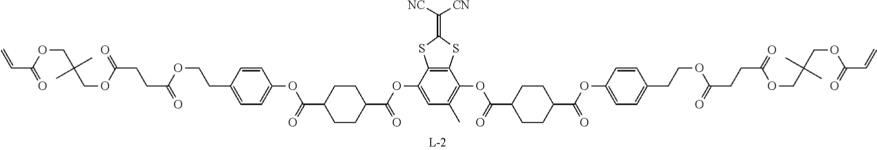 [SMILES: C=CC(=O)OCC(C)(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]

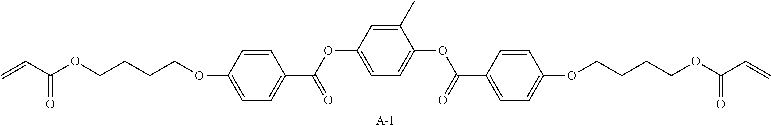 [SMILES: C=CC(=O)OCCCCOc1ccc(C(=O)Oc2ccc(OC(=O)c3ccc(OCCCCOC(=O)C=C)cc3)c(C)c2)cc1 ; "A-1"]

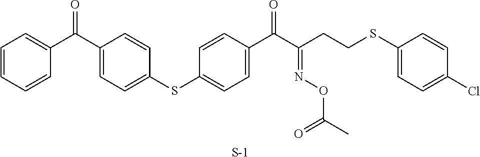

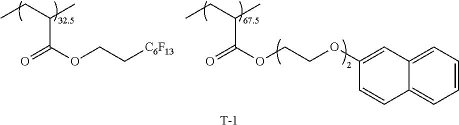

<Formation of Overcoat Layer>

A coating solution 1 for an overcoat layer having the following composition obtained by formulating pentaerythritol tetraacrylate (A-TMMT, molecular weight: 352, number of functional groups: 4, manufactured by Shin-Nakamura Chemical Co., Ltd.) as a polyfunctional polymerizable monomer was applied to the optically anisotropic layer 1 by a bar coating method (bar: #15), and then dried at 85° C. for 1 minutes to form an overcoat composition layer 1.

The formed overcoat composition layer 1 was heated on a hot plate at 70° C. and irradiated with ultraviolet rays to fix the alignment. Thus, an overcoat layer having a thickness of 5 μm was formed.

Coating Solution 1 for overcoat layer

| | |
|---|---|
| A-TMMT (manufactured by Shin-Nakamura Chemical Co., Ltd.) | 100.00 parts by mass |
| IRGACURE OXE-01 (manufactured by BASF SE) | 1.00 part by mass |
| Leveling agent (Compound T-2 shown below) | 0.20 parts by mass |
| Methyl ethyl ketone | 236.10 parts by mass |

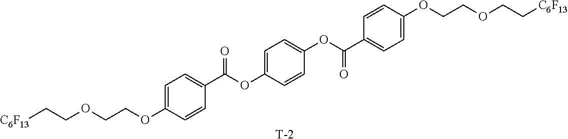

<Formation of Pressure Sensitive Adhesive Layer>

First, an acrylate-based polymer used for the pressure sensitive adhesive layer was prepared in the following procedure.

Specifically, 100 parts of butyl acrylate, 3 parts of acrylic acid, and 0.3 parts of 2,2′-azobisisobutyronitrile were placed in a reaction vessel provided with a cooling pipe, a nitrogen introduction pipe, a thermometer, and a stirrer with ethyl acetate under a nitrogen gas stream with a concentration of a solid content of 30% and were allowed to react at 60° C. for 4 hours to obtain an acrylate-based polymer (AC1) solution.

Next, the resulting acrylate-based polymer solution was used to form a pressure sensitive adhesive layer according to the following procedure. 2 parts of trimethylolpropane tolylene diisocyanate (CORONATE L, manufactured by Nippon Polyurethane Industry Co., LTD.) and 0.1 parts of 3-glycidoxypropyltrimethoxysilane were added to 100 parts of the solid content of the acrylate-based polymer solution to prepare a mixed solution.

Next, a mixed solution prepared by using a die coater was applied to a separate film surface treated with a silicone release agent and dried at 150° C. for 3 hours to obtain an acrylate-based pressure sensitive adhesive. The acrylate-based pressure sensitive adhesive and the separate film were laminated on the overcoat layer together and then only the separate film was peeled off to form a pressure sensitive adhesive layer formed of only the acrylate-based pressure sensitive adhesive on the overcoat layer.

### Example 2

An optical film was prepared in the same manner as in Example 1 except that instead of using the coating solution 1 for an overcoat layer, a coating solution 2 for an overcoat layer having the following composition formulated with dipentaerythritol hexaacrylate (A-DPH, molecular weight: 578, number of functional groups: 6, manufactured by Shin-Nakamura Chemical Co., Ltd.) as a polyfunctional polymerizable monomer was used.

Coating Solution 2 for Overcoat Layer

| | |
|---|---|
| A-DPH (manufactured by Shin-Nakamura | 100.00 parts by mass |
| Chemical Co., Ltd.) | |
| IRGACURE OXE-01 (manufactured by BASF | 1.00 part by mass |
| SE) | |
| Leveling agent (Compound T-2 shown above) | 0.20 parts by mass |
| Methyl ethyl ketone | 236.10 parts by mass |

### Example 3

An optical film was prepared in the same manner as in Example 1 except that instead of using the coating solution 1 for an overcoat layer, a coating solution 3 for an overcoat layer having the following composition formulated with urethane acrylate (U-10PA, molecular weight: 900, number of functional groups: 10, manufactured by Shin-Nakamura Chemical Co., Ltd.) as a polyfunctional polymerizable monomer was used.

Coating Solution 3 for Overcoat Layer

| | |
|---|---|
| U-10PA (manufactured by Shin-Nakamura | 100.00 parts by mass |
| Chemical Co., Ltd.) | |
| IRGACURE OXE-01 (manufactured by BASF | 1.00 part by mass |
| SE) | |
| Leveling agent (Compound T-2 shown above) | 0.20 parts by mass |
| Methyl ethyl ketone | 236.10 parts by mass |

### Example 4

An optical film was prepared in the same manner as in Example 1 except that instead of using the coating solution 1 for an overcoat layer, a coating solution 4 for an overcoat layer having the following composition formulated with a pentaerythritol triacrylate isophorone diisocyanate urethane prepolymer (UA-306I, molecular weight: 800, number of functional groups: 6, manufactured by Kyoeisha Chemical Co., Ltd.) as a polyfunctional polymerizable monomer was used.

Coating Solution 4 for Overcoat Layer

| | |
|---|---|
| UA-306I (manufactured by Kyoeisha | 100.00 parts by mass |
| Chemical Co., Ltd.) | |
| IRGACURE OXE-01 (manufactured by BASF | 1.00 part by mass |
| SE) | |
| Leveling agent (Compound T-2 shown above) | 0.20 parts by mass |
| Methyl ethyl ketone | 236.10 parts by mass |

### Example 5

An optical film was prepared in the same manner as in Example 2 except that instead of using the coating solution 1 for an optically anisotropic layer in Example 2, a coating solution 2 for an optically anisotropic layer having the following composition was used.

Coating Solution 2 for Optically Anisotropic Layer

| | |
|---|---|
| Liquid crystal compound L-7 shown below | 93.00 parts by mass |
| Liquid crystal compound A-1 shown above | 7.00 parts by mass |
| Polymerization initiator S-1 (oxime type) shown above | 3.00 parts by mass |
| Leveling agent (Compound T-1 shown above) | 0.20 parts by mass |
| Methyl ethyl ketone | 219.30 parts by mass |

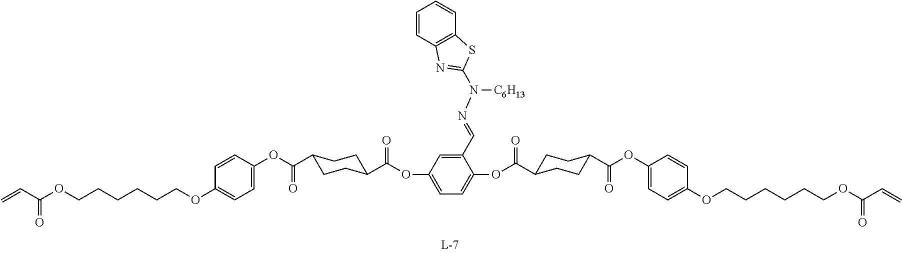

### Example 6

An optical film was prepared in the same manner as in Example 3 except that instead of using the coating solution 1 for an optically anisotropic layer in Example 3, the coating solution 2 for an optically anisotropic layer used in Example 5 was used.

### Example 7

An optical film was prepared in the same manner as in Example 2 except that instead of using the coating solution 1 for an optically anisotropic layer in Example 2, a coating solution 3 for an optically anisotropic layer having the following composition was used.

Coating Solution 3 for Optically Anisotropic Layer

| | |
|---|---|
| Liquid crystal compound L-8 shown below | 93.00 parts by mass |
| Liquid crystal compound A-1 shown above | 7.00 parts by mass |
| Polymerization initiator S-1 (oxime type) shown above | 3.00 parts by mass |
| Leveling agent (Compound T-1 shown above) | 0.20 parts by mass |
| Methyl ethyl ketone | 219.30 parts by mass |

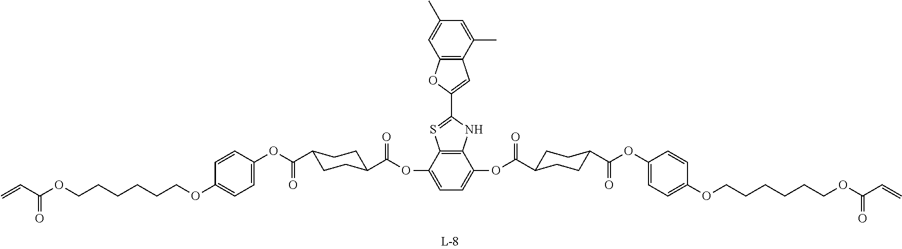

### Example 8

An optical film was prepared in the same manner as in Example 3 except that instead of using the coating solution 1 for an optically anisotropic layer in Example 3, the coating solution 3 for an optically anisotropic layer used in Example 7 was used.

### Comparative Example 1

An optical film was prepared in the same manner as in Example 1 except that the overcoat layer in Example 1 was not formed.

### Comparative Example 2

An optical film was prepared in the same manner as in Example 1 except that instead of using a coating solution 1 for an overcoat layer, a coating solution 5 for an overcoat layer having the following composition formulated with an aminoethylated acrylic polymer (POLYMENT (registered trademark) NK-350, weight average molecular weight: 100,000, manufactured by Nippon Shokubai Co., Ltd.) was used. The aminoethylated acrylic polymer formulated in the coating solution for an overcoat layer does not have a polymerizable group, “molecular weight/number of functional groups” in Table 1 below is denoted as “-”.

Coating Solution 5 for Overcoat Layer

| | |
|---|---|
| POLYMENT NK-350 (manufactured by Nippon | 100.00 parts by mass |
| Shokubai Co., Ltd.) | |
| Leveling agent (Compound T-2 shown above) | 0.20 parts by mass |
| Methyl ethyl ketone | 236.10 parts by mass |

### Comparative Example 3

An optical film was prepared in the same manner as in Example 1 except that instead of using the coating solution 1 for an overcoat layer, a coating solution 6 for an overcoat layer having the following composition formulated with U-4HA (molecular weight: 600, number of functional groups: 4, manufactured by Shin-Nakamura Chemical Co., Ltd.) as a polyfunctional polymerizable monomer was used.

Coating Solution 6 for Overcoat Layer

| | |
|---|---|
| U-4HA (manufactured by Shin-Nakamura | 100.00 parts by mass |
| Chemical Co., Ltd.) | |
| IRGACURE OXE-01 (manufactured by BASF | 1.00 part by mass |
| SE) | |
| Leveling agent (Compound T-2 shown above) | 0.20 parts by mass |
| Methyl ethyl ketone | 236.10 parts by mass |

### Reference Example 1

An optical film was prepared in the same manner as in Example 1 except that both the overcoat layer and the pressure sensitive adhesive layer were not formed.

### Reference Example 2

An optical film was prepared in the same manner as in Example 2 except that the pressure sensitive adhesive layer was not formed.

### Reference Example 3

An optical film was prepared in the same manner as in Example 1 except that the overcoat layer was not formed and instead of using the pressure sensitive adhesive layer, a UV adhesive (LCR0632, manufactured by Toagosei Co., Ltd.) was used.

For each of the optical films prepared, the glass transition temperature of the overcoat layer was measured in the above-described method. The results are shown in Table 1 below. In Table 1 below, the overcoat layer in which the glass transition temperature is not observed is denoted as “not observed”.

<Durability>

For each of the optical films prepared, the optically anisotropic layer side was directed to the glass side and was laminated on the glass substrate with a pressure sensitive adhesive.

The durability of the retardation value was evaluated based on the standards below using Axo Scan (0PMF-1, manufactured by Axometrics Inc.). The results are shown in Table 1 below.

The test conditions were as shown in Table 1 below, and the test was conducted by leaving each film to stand in an environment at 85° C. and a relative humidity of 85% for 5 days.

A: A change amount of the value after test with respect to the initial phase difference value is less than 2%.

B: A change amount of the value after test with respect to the initial phase difference value is 2% or more and less than 4%.

C: A change amount of the value after test with respect to the initial phase difference value is 4% or more and less than 6%.

D: A change amount of the value after test with respect to the initial phase difference value is 6% or more.

TABLE 1

| | | Overcoat layer | | | | |
|---|---|---|---|---|---|---|
| | | Polyfunctional polymerizable | | | | Durability |
| | | monomer | | | | 85° C. |
| | | | Molecular | Glass | Pressure | relative |
| | Optically | | weight/number | transition | sensitive | humidity |
| | anisotropic | | of functional | temperature | adhesive | 85% |
| | layer | Kind | groups | ° C. | layer | 5 days |
| Example 1 | 1 | A-TMMT | 88 | Not observed | Provided | B |
| Example 2 | 1 | A-DPH | 96 | Not observed | Provided | A |
| Example 3 | 1 | U-10PA | 90 | Not observed | Provided | A |
| Example 4 | 1 | UA-306I | 133 | Not observed | Provided | B |
| Example 5 | 2 | A-DPH | 96 | Not observed | Provided | A |
| Example 6 | 2 | U-10PA | 90 | Not observed | Provided | A |
| Example 7 | 3 | A-DPH | 96 | Not observed | Provided | A |
| Example 8 | 3 | U-10PA | 90 | Not observed | Provided | A |
| Comparative | 1 | None | — | — | Provided | D |
| Example 1 | | | | | | |
| Comparative | 1 | POLYMENT | — | 40 | Provided | D |
| Example 2 | | NK-350 | | | | |
| Comparative | 1 | U-4HA | 150 | Not observed | Provided | D |
| Example 3 | | | | | | |
| Reference | 1 | None | — | — | Not | A |
| Example 1 | | | | | provided | |
| Reference | 1 | A-DPH | 96 | Not observed | Not | A |
| Example 2 | | | | | provided | |
| Reference | 1 | None | — | — | UV adhesive | A |
| Example 3 | | | | | | |

From the results shown in Table 1, it was found that in a case where the overcoat layer was not formed and the pressure sensitive adhesive layer was provided, the durability was deteriorated (Comparative Example 1).

It was found that in a case where the aminoethylated acrylic polymer not having a polymerizable group was used to form the overcoat layer, the durability was deteriorated (Comparative Example 2).

It was found that in a case where the polyfunctional polymerizable monomer of which the molecular weight per polymerizable group in the polyfunctional polymerizable monomer was more than 140 was used to form the overcoat layer, the durability was deteriorated (Comparative Example 3).

In contrast, in a case where the polyfunctional polymerizable monomer of which the molecular weight per polymerizable group in the polyfunctional polymerizable monomer was 140 or less was used to form the overcoat layer between the optically anisotropic layer and the pressure sensitive adhesive layer, durability a level comparable to the durability in a case where the pressure sensitive adhesive layer was not provided or an aspect in which the UV adhesive was used, that is, Reference Examples 1 to 3 not having problems was obtained (Examples 1 to 8).

Further, from the comparison of Examples 1 to 8, it was found in a case where the molecular weight per polymerizable group in the polyfunctional polymerizable monomer is 90 to 135, the durability was further improved.

### EXPLANATION OF REFERENCES

10: optical film
12: optically anisotropic layer
14: overcoat layer
16: pressure sensitive adhesive layer
20: polarizing plate
22: polarizer
30: liquid crystal display device
32: liquid crystal cell
40: organic EL display device
42: organic EL panel

What is claimed is:

1. An optical film comprising, in order:
an optically anisotropic layer;
an overcoat layer; and
a pressure sensitive adhesive layer,
wherein the optically anisotropic layer is a layer obtained by polymerizing a polymerizable liquid crystal composition containing a liquid crystal compound having a polymerizable group and a polymerization initiator,
the overcoat layer is a layer obtained by curing a polyfunctional polymerizable monomer having two or more polymerizable groups, and
a molecular weight per polymerizable group in the polyfunctional polymerizable monomer is 140 or less.

2. The optical film according to claim 1,
wherein the overcoat layer is a layer having no glass transition temperature or a layer having a glass transition temperature of 80° C. or higher.

3. The optical film according to claim 1,
wherein the polymerizable group of the polyfunctional polymerizable monomer is an acryloyl group or a methacryloyl group.

4. The optical film according to claim 1,
wherein the liquid crystal compound is a liquid crystal compound represented by Formula (1), 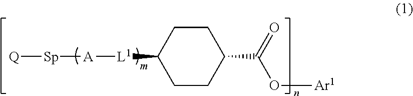
in Formula (1),
Ar¹ represents an n-valent aromatic group,
L¹ represents a single bond, —COO—, or —OCO—,
A represents an aromatic ring having 6 or more carbon atoms or a cycloalkylene ring having 6 or more carbon atoms,
Sp represents a single bond, a linear or branched alkylene group having 1 to 12 carbon atoms, or a divalent linking group in which one or more —CH₂— groups that constitute a linear or branched alkylene group having 1 to 12 carbon atoms are substituted with —O—, —S—, —NH—, —N(Q)-, or —CO—,
Q represents a polymerizable group,
m represents an integer of 0 to 2, and
n represents an integer of 1 or 2,
where all of L¹, A, Sp, and Q, a plurality of which are provided depending on the number of m or n, may be the same or different from each other.

5. The optical film according to claim 1,
wherein the polymerizable group of the liquid crystal compound is an acryloyl group or a methacryloyl group.

6. The optical film according to claim 1,
wherein the liquid crystal compound is a liquid crystal compound exhibiting reciprocal wavelength dispersion.

7. A polarizing plate comprising:
the optical film according to claim 1; and
a polarizer.

8. An image display device comprising:
the optical film according to claim 1.

9. The optical film according to claim 2,
wherein the polymerizable group of the polyfunctional polymerizable monomer is an acryloyl group or a methacryloyl group.

10. The optical film according to claim 2,
wherein the liquid crystal compound is a liquid crystal compound represented by Formula (1), 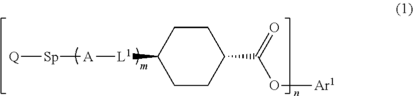
in Formula (1),
Ar¹ represents an n-valent aromatic group,
L¹ represents a single bond, —COO—, or —OCO—,
A represents an aromatic ring having 6 or more carbon atoms or a cycloalkylene ring having 6 or more carbon atoms,
Sp represents a single bond, a linear or branched alkylene group having 1 to 12 carbon atoms, or a divalent linking group in which one or more —CH₂— groups that constitute a linear or branched alkylene group having 1 to 12 carbon atoms are substituted with —O—, —S—, —NH—, —N(Q)-, or —CO—,
Q represents a polymerizable group,
m represents an integer of 0 to 2, and
n represents an integer of 1 or 2,
where all of L¹, A, Sp, and Q, a plurality of which are provided depending on the number of m or n, may be the same or different from each other.

11. The optical film according to claim 3,
wherein the liquid crystal compound is a liquid crystal compound represented by Formula (1), 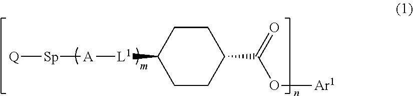
in Formula (1),
Ar¹ represents an n-valent aromatic group,
L¹ represents a single bond, —COO—, or —OCO—,
A represents an aromatic ring having 6 or more carbon atoms or a cycloalkylene ring having 6 or more carbon atoms,
Sp represents a single bond, a linear or branched alkylene group having 1 to 12 carbon atoms, or a divalent linking group in which one or more —CH₂— groups that constitute a linear or branched alkylene group having 1 to 12 carbon atoms are substituted with —O—, —S—, —NH—, —N(Q)-, or —CO—,
Q represents a polymerizable group,
m represents an integer of 0 to 2, and
n represents an integer of 1 or 2,
where all of L¹, A, Sp, and Q, a plurality of which are provided depending on the number of m or n, may be the same or different from each other.

12. The optical film according to claim 2,
wherein the polymerizable group of the liquid crystal compound is an acryloyl group or a methacryloyl group.

13. The optical film according to claim 3,
wherein the polymerizable group of the liquid crystal compound is an acryloyl group or a methacryloyl group.

14. The optical film according to claim 4,
wherein the polymerizable group of the liquid crystal compound is an acryloyl group or a methacryloyl group.

15. The optical film according to claim 2,
wherein the liquid crystal compound is a liquid crystal compound exhibiting reciprocal wavelength dispersion.

16. The optical film according to claim 3,
wherein the liquid crystal compound is a liquid crystal compound exhibiting reciprocal wavelength dispersion.

17. The optical film according to claim 4,
wherein the liquid crystal compound is a liquid crystal compound exhibiting reciprocal wavelength dispersion.

18. The optical film according to claim 5,
wherein the liquid crystal compound is a liquid crystal compound exhibiting reciprocal wavelength dispersion.

19. A polarizing plate comprising:
the optical film according to claim 2; and
a polarizer.

20. A polarizing plate comprising:
the optical film according to claim 3; and
a polarizer.
